(19) United States
(12) Patent Application Publication
(10) Pub. No.: US 2023/0324872 A1
(43) Pub. Date: Oct. 12, 2023

(54) SERVO CONTROL DEVICE

(71) Applicant: FANUC CORPORATION, Yamanashi (JP)

(72) Inventors: Shun TAKARAZAWA, Yamanashi (JP); Satoshi IKAI, Yamanashi (JP)

(73) Assignee: FANUC CORPORATION, Yamanashi (JP)

(21) Appl. No.: 18/044,106

(22) PCT Filed: Oct. 21, 2021
(86) PCT No.: PCT/JP2021/038960

§ 371 Date: Mar. 6, 2023

(30) Foreign Application Priority Data
Oct. 28, 2020 (JP) 2020-180253

(51) Int. Cl. G05B 19/404

(52) U.S. Cl. CPC G05B 19/404; G05B 2219/41032; G05B 2219/41078; G05B 2219/42298

(57) ABSTRACT

Regarding a backlash amount measurement system provided in the servo control device of the drive motor of machine tools and industrial machines, a technical problem is to accurately measure the backlash amount at the time of inversion of a drive shaft by means of a backlash amount measurement system having a simpler configuration with a small number of detectors. The above technical problem can be solved by a backlash amount measuring unit equipped with an inversion detection unit which detects the start of inversion of the shaft, an arrival detection unit which detects that the backlash end has been reached from the start of inversion, and a time/distance measurement unit which measures the time from when the inversion detection unit detects the start of inversion until the arrival detection unit detects that the backlash end has been reached, or the movement distance.

### TECHNICAL FIELD

The present invention relates to a servo control device for a motor drive shaft, and more particularly, to a servo control device having a function of measuring an amount of backlash of a motor drive shaft that is driven and controlled by a servo motor.

### BACKGROUND ART

In a case of driving and controlling a drive shaft of a machine tool or an industrial machine, a backlash that occurs when the drive shaft is reversed is one of factors of deterioration of control accuracy. Therefore, in order to improve the control accuracy for such a drive shaft, a control has been performed according to which an amount of backlash that occurs when the drive shaft is reversed is measured and taken into account.

Patent Document 1 discloses a numerical controller in which a position control unit reads, in accordance with a movement command instructing a shaft to reciprocate, position detection data regarding a movable part of a machine and rotational position detection data regarding a motor, stores the read data in a storage unit, and automatically measures an amount of backlash by comparing the data with each other when a series of reciprocating movements is completed.

Patent Document 2 discloses that a period from a point in time at which a drive target starts to reverse to a point in time at which the drive target starts to move is measured, a backlash drive time is determined from the measured period, a motor is driven for the backlash drive time to cancel the backlash, and then a substantial drive control is started.

Patent Document 3 discloses that a robot controller detects an amount of backlash from a difference between an angle of each joint calculated from an encoder value detected by an encoder provided to each actuator, and an angle of each joint corresponding to an angle of a retaining tool calculated from an inertial force detected by an inertia sensor attached to the retaining tool.
Patent Document 1: Japanese Unexamined Patent Application, Publication No. H04-250950
Patent Document 2: Japanese Unexamined Patent Application, Publication No. 2003-224994
Patent Document 3: Japanese Unexamined Patent Application, Publication No. 2011-42022

### DISCLOSURE OF THE INVENTION

### Problems to be Solved by the Invention

As described above, it has been known to attempt to improve the accuracy of drive control for a drive shaft of a machine tool and a drive shaft of an industrial machine by detecting an amount of backlash occurring at the drive shaft at the time of reversing and by controlling the drive shaft in consideration of the amount of backlash. However, the detection of the amount of backlash according to Patent Documents 1 to 3 requires a number of detectors, and the resultant large-scale detection system has a large size and incurs high costs. There is a demand for a system that has a simpler configuration than conventional systems and is capable of accurately measuring an amount of backlash.

Under the circumstances described above, it is an object of the present disclosure to construct a system adapted for a servo motor control device for a machine tool or an industrial machine, having a simpler configuration with a reduced number of detectors, and capable of accurately measuring an amount of backlash that occurs when a drive shaft reverses.

### Means for Solving the Problems

To achieve the above object, the present disclosure provides a servo control device for a motor configured to drive a drive shaft of a machine tool or a drive shaft of an industrial machine. The servo control device includes a control unit configured to control driving of the motor based on a movement command; and a backlash amount measurement unit configured to measure an amount of backlash that occurs when the drive shaft is reversed. The backlash amount measurement unit includes a reverse detection unit configured to detect a start of reverse of the drive shaft, based on a position command, a speed command, a position detection value, or a speed detection value, an arrival detection unit configured to detect arrival of the drive shaft at a backlash end from the start of reverse, based on a command or a detection value, and a time/distance measurement unit configured to measure a period of time or a movement distance from detection of the start of reverse by the reverse detection unit to detection of the arrival at the backlash end by the arrival detection unit.

### Effects of the Invention

A servo control device according to the present disclosure is adapted for controlling a drive motor of a machine tool or an industrial machine, is provided with a backlash amount measurement system, has a simpler configuration with a small number of detectors, and is capable of accurately measuring an amount of backlash that occurs when a drive shaft reverses.

### BRIEF DESCRIPTION OF THE DRAWINGS

FIG. 1 is a block diagram illustrating a flow of signals exchanged between a servo control device according to the present disclosure and a motor device;

FIG. 2 is a diagram for explaining a definition of a reverse start and a definition of a backlash end;

FIG. 3 is a diagram illustrating a method of detecting arrival at a backlash end; and

FIG. 4 is a flowchart illustrating a method of measuring an amount of backlash according to the present disclosure.

### PREFERRED MODE FOR CARRYING OUT THE INVENTION

Embodiments of the present disclosure will be described below in detail with reference to the drawings.

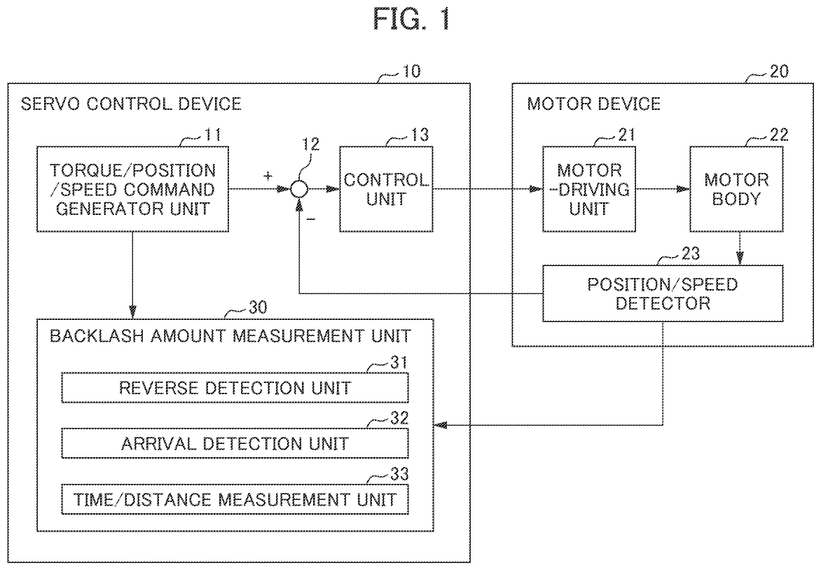

FIG. 1 is a block diagram illustrating a flow of signals exchanged between a servo control device 10 according to an embodiment of the present disclosure and a motor device 20. As illustrated in FIG. 1, the servo control device 10 that drives and controls a motor transmits a drive command signal to the motor device 20, while the motor device 20 returns a feedback signal, a detection information signal, etc. to the servo control device 10.

The servo control device 10 includes a torque/position/speed command generator unit 11, an adder 12, a control unit 13, and a backlash amount measurement unit 30. The torque/position/speed command generator unit 11 calculates a torque command value, a position command value, and a speed command value for driving the motor, based on a specification in a user program or a command from an upper control device. Note that a speed command may be a value calculated by differentiating a position command with time, and a torque command may be a value calculated by multiplying an acceleration command obtained by differentiating the speed command with time, by inertia obtained by totaling, for example, inertia of the motor device 20 and inertia of the drive shaft.

The torque command value, the position command value, and the speed command value calculated and generated by the torque/position/speed command generator unit 11 are outputted to the adder 12, and a torque value, a position value, and a speed value detected by and fed back from the motor device 20 are subtracted from the command values, thereby determining deviations between the command values and the detection values. The adder 12 outputs command values corresponding to the deviations of the torque, position, and speed command values from the torque, position, and speed detection values, and the command values outputted from the adder 12 are inputted to the control unit 13. The control unit 13, in which known control, such as PID control, learning control, or the like is applied in accordance with the characteristics of the motor device 20 and required control accuracy and characteristics, provides a resultant output to the motor device 20.

The motor device 20 includes a motor-driving unit 21, a motor body 22, and a position/speed detector 23. In response to the command values outputted from the servo control device 10, the motor-driving unit 21 generates starting power prescribed in a motor-to-motor basis, and rotationally drives the motor body 22. The position/speed detector 23 detects a rotational position and a rotational speed (rotation number) of the rotation of the motor body 22. An acceleration is calculated by differentiating the detected speed of the motor with time, and an actual torque value generated in the motor device 20 or the like can be determined by multiplying the calculated acceleration by inertia of the motor device 20, the drive shaft, or the like.

As mentioned above, the position and speed (rotation number) of the motor body 22 detected by the position/speed detector 23 and the actual torque value calculated from the position and speed (rotation number) of the motor body 22 detected by the position/speed detector 23 are fed back to the servo control device 10, and then outputted to the adder 12 and transmitted also to the backlash amount measurement unit 30.

The backlash amount measurement unit 30 includes a reverse detection unit 31, an arrival detection unit 32, and a time/distance measurement unit 33. Upon receiving a signal from the torque/position/speed command generator unit 11 or a detection signal from the position/speed detector 23 of the motor device 20, the reverse detection unit 31 detects a start of reverse while the arrival detection unit 32 detects arrival at a backlash end. The time/distance measurement unit 33 calculates an amount of backlash based on results of the foregoing detection. This detection and calculation method will be described later in detail.

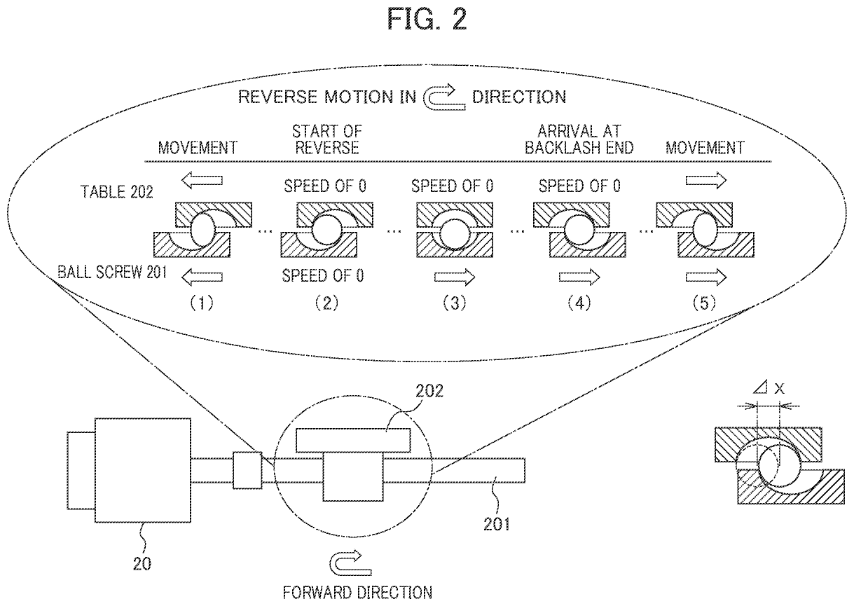

Next, the definition of the amount of backlash according to the present disclosure will be described with reference to FIG. 2. FIG. 2 illustrates, in the upper part thereof, a relative positional relationship between a table 202 and a screw (ball screw 201) with a ball bearing interposed therebetween in several states in chronological order, from a state in which the ball screw 201 starts to be rotationally driven by the motor device 20 so as to move the table 202 in a forward direction, to a state in which the ball screw 201 is reversed so as to move the table 202 in a backward direction.

Among the five subfigures chronologically indicating the relative positional relationship between the table 202 and the ball screw 201 in the upper part of FIG. 2, the subfigure (1) at the left end indicates a state in which the table 202 is being moved in the forward direction due to the rotation of the ball screw 201. The ball functioning as a bearing between the table 202 and the threaded portion of the ball screw 201 is in close contact with the table 202 and the threaded portion, and is receiving a load for transmitting a force in the forward direction. To indicate this condition, the ball is depicted in an oval shape.

The subfigure (2) second from the left in the upper part of FIG. 2 indicates a state in which the ball screw 201 starts to be reversed and the ball between the table 202 and the screw portion is receiving no load in the forward direction. That is, the subfigure (2) indicates a point in time at which a relative speed of the table 202 with respect to the ball screw 201 becomes equal to 0 in response to movement commands for torque, position, and speed directed to the motor device 20. The point in time corresponding to this state is defined as the reverse start time point in the present disclosure. Thus, detection of the relative speed of the table 202 with respect to the ball screw 201 becoming equal to 0 by the reverse detection unit 31 is regarded as detection of reverse of the speed command or reverse of the feedback, whereby the start of reverse is detected.

The subfigure (3) at the center of the upper part of FIG. 2 indicates a state in the middle of the change from the detection of the start of reverse to arrival at a backlash end. In the state indicated by the subfigure (3), the ball interposed between the table 202 and the threaded portion remains under no load in the forward direction, and occurrence of backlash continues. The ball screw 201 then arrives at the backlash end, whereby the state indicated by the subfigure (4) second from the right is brought about. In the state indicated by the subfigure (4), the ball is receiving a load in the direction opposite to the forward direction.

Subsequently, a state indicated by the subfigure (5) at the right end is brought about, in which the table 202 is being moved in the direction opposite to the forward direction due to the rotation of the ball screw 201 in the reverse direction.

Thus, it is defined that the backlash starts at the point in time at which the relative speed of the table 202 with respect to the ball screw 201 becomes equal to 0 in response to the start of reverse of the speed command or the speed feedback, which is indicated by the second subfigure from the left in FIG. 2, and ends at the point in time at which the ball screw 201 arrives at the backlash end, which is indicated by the second subfigure from the right in FIG. 2. A relative movement distance by which the table 202 moves with respect to the ball screw 201 or a relative movement distance by which the ball screw 201 moves with respect to the table 202 during the period from the start to end of the backlash is defined as an amount of backlash. The amount of backlash corresponds to a movement distance by which the ball interposed between the table 202 and the screw portion moves, and is indicated by Δx in the right subfigure in the lower part of FIG. 2.

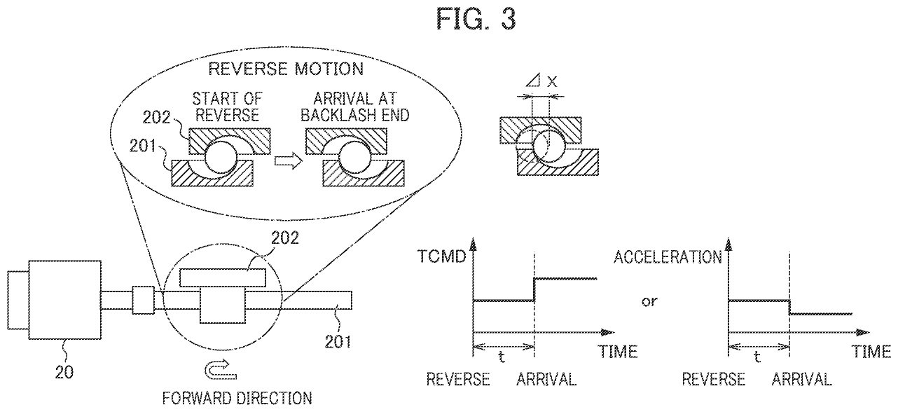

In other words, the amount of backlash is determined by detecting the reverse start time point indicated by the second subfigure from the left and the backlash arrival time point indicated by the second subfigure from the right in the upper part of FIG. 2, and calculating the movement distance therebetween. As described above, the reverse start time point indicated by the second subfigure from the left can be detected by detecting the point in time at which the relative speed of the table 202 with respect to the ball screw 201 becomes equal to 0. Next, detection of the point in time at which the ball screw 201 arrives at the backlash end will be described in detail with reference to FIGS. 2 and 3.

In the present disclosure, a case will be discussed in which the point in time at which the ball screw 201 arrives at the backlash end is detected upon a change in a torque command or a change in an acceleration caused by the ball screw 201 arriving at the backlash end. Here, for the system (model) illustrated in FIGS. 2 and 3 in which the ball screw 201 is rotated by the motor device 20 so as to move the table 202, inertia of the system will be described. The motor device 20, the ball screw 201, and the table 202 forming the illustrated system are assumed to have an equal inertia J_{M} in order for simplification of the description of the model.

Reference is made to the state before the arrival at the backlash end following occurrence of the backlash, i.e., the state indicated by the subfigure (3) at the center of the upper part of FIG. 2. According to the model of this system, only two elements, which are the motor device 20 and the ball screw 201, are in motion in this state, and a total inertia J_{Σ} of this system is given by:

[Formula 1]

J_{Σ}=2J_{M} Formula (1)

On the other hand, in the state in which the ball screw 201 has arrived at the backlash end, i.e., in the state indicated by the subfigure (4) second from the right in the upper part of FIG. 2, according to the model of this system, three elements, which are the motor device 20, the ball screw 201, and the table 202 are in motion, and a total inertia J_{Σ} of this system is given by:

[Formula 2]

J_{Σ}=3J_{M} Formula (2)

It is known that a relationship between a torque command T_{cmd} and an actual torque T is expressed by Formula (3) below:

[Formula 3]

T_{cmd}[%]=(T×100)/(Kₜ×Iₘₐₓ) Formula (3)

In this formula, T_{cmd} [%] represents the torque command, T [Nm] represents the actual torque, Kₜ [Nm/Ap] represents a torque constant of a motor, and Iₘₐₓ [Ap] represents an amplifier maximum current. The actual torque T [Nm] is defined by Formula (4) below.

[Formula 4]

T[Nm]=J_{Σ}×(dω/dt) Formula (4)

In this Formula, co represents an angular speed, and dω/dt represents an angular acceleration.

Accordingly, in a case where a control is performed such that the angular acceleration (dω/dt) will be constant, the change from the state in which the ball screw 201 does not yet arrive at the backlash end to the state in which the ball screw 201 has arrived at the backlash end can be detected by detecting a change from a torque command value before the arrival at the backlash end, which is given by substituting Formulas (4) and (1) into Formula (3), to a toque command value at the time of the arrival at the backlash end, which is given by substituting Formulas (4) and (2) into Formula (3). Under a precondition that the angular acceleration dω/dt is constant, since a value calculated by substituting Formulas (4) and (2) into Formula (3) is 1.5 times a value calculated by substituting Formulas (4) and (1) into Formula (3), the arrival at the backlash end can be detected by detecting that the torque command value has increased by 1.5 times. In contrast, in a case where a control is performed such that the torque command will be constant, the arrival at the backlash end can be detected by detecting that the angular acceleration has decreased to ⅔.

A case in which the torque command value has increased by 1.5 times at a lapse of a time t from detection of the start of reverse to detection of the arrival at the backlash end is represented in the left graph in the lower right part of FIG. 3. In the left graph shown in the lower right part of FIG. 3, the vertical axis represents the torque command value TCMD, and the horizontal axis represents time. A case in which the acceleration has decreased to ⅔ at a lapse of a time t from detection of the start of reverse to detection of the arrival at the backlash end is represented in the right graph shown in the lower right part of FIG. 3. In the right graph shown in the lower right part of FIG. 3, the vertical axis represents acceleration and the horizontal axis represents time.

It is also known that a relationship between the angular acceleration (dω/dt) of the ball screw 201 and a translational acceleration a of the table 202 is expressed by Formula (5) below.

[Formula 5]

dω/dt[rad/s²]=(2π/(L×10⁻³))×a Formula (5)

In this formula, L [mm] represents a lead of the ball screw 201, and a [m/s²] represents the translational acceleration of the ball screw 201. Further, it is known that a relationship between the translational acceleration a and the amount of backlash Δx is expressed by Formula (6) below.

[Formula 6]

a[m/s²]=2×10⁻⁶×(Δx/t²) Formula (6)

Since the model of the system has the inertia given by Formula (1) during the occurrence of the backlash, the amount of backlash Δx is expressed by Formula (7) below, based on Formulas (1) and (3) to (6).

[Formula 7]

Δx=(1/(8π×10¹¹))×(Kₜ×Iₘₐₓ×L/J_{M})×T_{cmd}×t² Formula (7)

Formula (7) enables detection of an amount of backlash provided that a control is performed such that the torque command T_{cmd} is constant, and a period of time from a point in time at which the start of reverse is detected to a point in time at which the arrival at the backlash end is measured. Alternatively, in a case where a movement distance can be measured, an amount of backlash is directly determined by way of measuring a movement distance from a point in time at which the start of reverse is detected to a point in time at which the arrival at the backlash end is detected.

Measurement of an amount of backlash using Formula (7) requires a high-speed measurement cycle equal to or shorter than a control cycle for the motor. In order to achieve more accurate measurement, for example, it is more preferable to perform the measurement in cycles equal to or shorter than one half of the control cycle for the motor. As a guide, a typical control cycle is set to 1 ms. Highly accurate measurement can be achieved by adopting a high-speed control cycle of the servo control device.

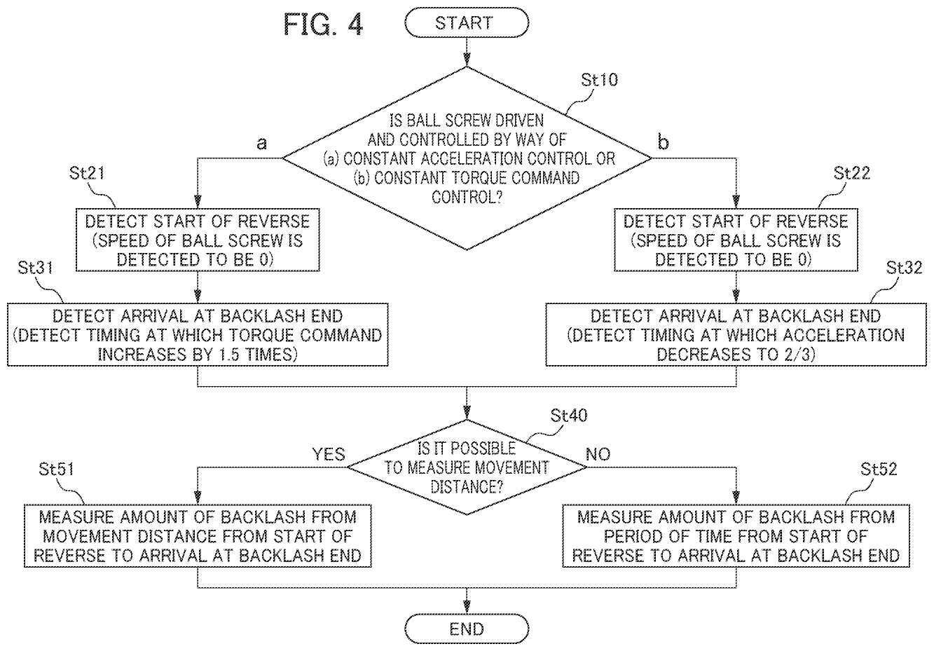

Next, one embodiment of a method of measuring an amount of backlash in the case of the servo control device according to the present disclosure will be described with reference to the flowchart in FIG. 4. First, it is determined whether the motor device, which is driven and controlled by the servo control device, controls and drives the ball screw by way of (a) constant acceleration control or (b) constant torque command control (Step St10). When the determination result is (a) the constant acceleration control, the process proceeds to Step St21, whereas when the determination result is (b) the constant torque command control, the process proceeds to Step St22.

In Step St21, a start of reverse of the ball screw is detected. Specifically, the start of reverse of the ball screw is detected when a speed of the ball screw is detected to be 0. Next, the process proceeds to Step St31, in which it is detected whether or not the ball screw has arrived at the backlash end. Specifically, in the case of the constant acceleration control, the arrival of the ball screw at the backlash end is detected upon detection of a timing at which the torque command increases by 1.5 times. Similarly, in Step St22, a start of reverse of the ball screw is detected. Specifically, the start of reverse of the ball screw is detected when a speed of the ball screw is detected to be 0. Next, the process proceeds to Step St32, in which it is detected whether or not the ball screw has arrived at the backlash end. Specifically, in the constant torque command control, the arrival of the ball screw at the backlash end is detected upon detection of a timing at which an acceleration decreases to ⅔.

After Steps St31 and St32, the process proceeds to Step

St40. In Step St40, it is determined whether or not a movement distance of the ball screw can be measured. For example, if a position of the ball screw can be detected, the movement distance of the ball screw can be measured from a difference between a position at which the ball screw started to reverse and a position at which the ball screw arrived at the backlash end. When the determination result is Yes, that is, when the movement distance of the ball screw can be measured, the process proceeds to Step St51. When the determination result is No, that is, when the movement distance of the ball screw cannot be measured, the process proceeds to Step St52.

In Step St51, an amount of backlash is measured from the movement distance between the position at which the ball screw started to reverse and the position at which the ball screw arrived at the backlash end. The measured movement distance from the position at which the ball screw started to reverse to the position at which the ball screw arrived at the backlash end is the amount of backlash. Once the amount of backlash is measured, the object of the present disclosure is achieved and the flow ends. In Step St52, the amount of backlash is measured based on a period of time from the start of the reverse of the ball screw to the arrival of ball screw at the backlash end. As in Step St51, once the amount of backlash is measured, the object of the present disclosure is achieved, and the flow ends.

As described above, according to the present disclosure, the amount of backlash at the ball screw is measured based on the detection of the start of reverse of the ball screw and the detection of the arrival of the ball screw at the backlash end. The start of reverse of the ball screw is detected when a speed of the ball screw is detected to be 0, and the arrival at the backlash end is detected by detecting a change in the torque command or a change in the acceleration. Therefore, only one detector provided to the motor device is required as a detector for detecting the position or speed (rotation number), and a separate detector is not needed. Therefore, in comparison with conventional backlash amount measurement systems, the number of required detectors can be reduced, and the amount of backlash can be accurately measured with a simpler configuration.

Further, the present disclosure is applicable to not only the case where the ball screw is driven and controlled by way of the constant acceleration control, but also the case where the ball screw is driven and controlled by way of the constant torque command control. Furthermore, the present disclosure makes it possible to measure the amount of backlash from not only a movement distance but also a period of time from the start of reverse of the ball screw to the arrival at the backlash end after detection of the start and the arrival. Hence, the present disclosure advantageously has great versatility and is applicable to various conditions.

While embodiments of the present invention have been described above to illustrate working of the present invention, but the present invention is not limited to the embodiments described above. Needless to say, the present invention can be implemented in various forms without departing from the spirit of the present invention.

### EXPLANATION OF REFERENCE NUMERALS

10: Servo control device
11: Torque/position/speed command generator unit
12: Adder
13: Control unit
20: Motor device
201: Ball screw
202: Table
21: Motor-driving unit
22: Motor body
23: Position/speed detector
30: Backlash amount measurement unit
31: Reverse detection unit
32: Arrival detection unit
33: Time/distance measurement unit

1. A servo control device for a motor configured to drive a drive shaft of a machine tool or a drive shaft of an industrial machine, the servo control device comprising:
a control unit configured to control driving of the motor based on a movement command; and
a backlash amount measurement unit configured to measure an amount of backlash that occurs when the drive shaft is reversed,
the backlash amount measurement unit comprising
a reverse detection unit configured to detect a start of reverse of the drive shaft, based on a position command, a speed command, a position detection value, or a speed detection value,
an arrival detection unit configured to detect arrival of the drive shaft at a backlash end after the start of reverse, based on a position command, a speed command, a position detection value, or a speed detection value, and
a time/distance measurement unit configured to measure a period of time or a movement distance from detection of the start of reverse by the reverse detection unit to detection of the arrival at the backlash end by the arrival detection unit.

2. The servo control device according to claim 1, wherein
only one detector for detecting a position or a speed of the motor is required for the backlash amount measurement unit to measure the amount of backlash.

3. The servo control device according to claim 1, wherein
the reverse detection unit performs detection upon reverse of a speed command or reverse of speed feedback.

4. The servo control device according to claim 1, wherein
the arrival detection unit performs detection based on one of a change in a torque command or a change in torque feedback, or one of a change in an acceleration command or a change in acceleration feedback.

5. The servo control device according to claim 1, wherein
the time/distance measurement unit performs measurement in a measurement cycle equal to or shorter than 1 ms.

6. The servo control device according to claim 1, wherein
the time/distance measurement unit performs measurement in a short measurement cycle only when measuring the amount of backlash.

7. The servo control device according to claim 1, wherein
when measuring the amount of backlash, the time/distance measurement unit performs measurement in a measurement cycle equal to or shorter than a control cycle in which a servo motor is driven and controlled.

8. The servo control device according to claim 1, wherein
when measuring the amount of backlash, the time/distance measurement unit performs measurement in a measurement cycle equal to or shorter than one half of a control cycle in which a servo motor is driven and controlled.
